(19) United States
(12) Patent Application Publication
(10) Pub. No.: US 2013/0004231 A1
(43) Pub. Date: Jan. 3, 2013

(54) APPLICATOR

(76) Inventors: Yasunori Nakatani, Osaka-shi (JP); Shohei Tsuchida, Osaka-shi (JP)

(21) Appl. No.: 13/583,400

(22) PCT Filed: Mar. 25, 2011
(86) PCT No.: PCT/JP2011/057293

§ 371 Date: Sep. 7, 2012

(30) Foreign Application Priority Data
Mar. 26, 2010 (JP) 2010-072715

(51) Int. Cl. B43K 8/06

(52) U.S. Cl. 401/198

(57) ABSTRACT

An applicator includes an application liquid reservoir in which filled application liquid is flowable, an applying body for applying the application liquid, an application liquid-occlusion body located between the application liquid reservoir and the applying body and designed to be impregnated with the application liquid, and a channel forming portion located between the application liquid reservoir and the occlusion body and having a channel in which the application liquid is flowable, wherein the channel forming portion has a protrusion, the protrusion having a cavity inside and more than one communication openings communicated with the cavity.

### TECHNICAL FIELD

The present invention relates to an applicator for supplying application liquid contained therein to an applying body such as a pen tip, and more particularly to an applicator provided with an application liquid supply means for stabilizing supply of application liquid to an applying body.

Herein, the applicator in this specification is used as the generic name for not only writing instruments such as a felt-tip pen, a fountain pen, a highlighter, and a whiteboard marker but also an instrument, such as a correction pen, to apply liquid to a discretionary object such as a paper and a white board.

### BACKGROUND ART

The conventionally known technology is to provide an inner absorber (application liquid-occlusion body) capable of being impregnated with ink (application liquid) in between a pen tip and an ink tank as an application liquid supply means for stably supplying the application liquid to the pen tip (applying body). According to such a technology, the inner absorber absorbs excess ink, thereby avoiding the ink from being supplied to the pen tip too much. Further, in case of ink shortage at the pen tip, the ink absorbed in the inner absorber is supplied to the pen tip, so as to prevent shortage of ink supply. That stably supplies the ink to the pen tip.

An applicator employing this technology includes, for example, a direct liquid-type writing instrument disclosed in a patent document 1 specified below. Such a direct liquid-type writing instrument is a so-called no operating-type writing instrument. The no operating-type writing instrument is designed to supply ink to a pen tip with no operation, such as clicking of the pen tip or a pen shaft, for ink supply. The invention disclosed in the patent document 1 uses a plurality of communication tubes connecting an ink occlusion body (application liquid-occlusion body) and an ink tank of this direct liquid-type writing instrument, so as to separate an air channel and an ink passage. That quickly exchanges air and ink, which reduces time to become able to write at initial use (when the ink is firstly supplied to the ink occlusion body from the ink tank).

### PATENT DOCUMENT

[Patent Document 1] JP 2006-212884 A

### DISCLOSURE OF INVENTION

### Technical Problem

However, the invention disclosed in the patent document 1 requires providing a plurality of communication tubes in structure. Compared with provision of one communication tube, that causes such problems that design limits such as a diameter and a thickness of each communication tube become tight and that formation of components become complicated. Besides, since more than one communication tubes work together, the writing instrument might become non-functional in a case of an accidental damage of any communication tube.

Further, the applicator having more than one communication tubes as described in the patent document 1 has design limits such that a main body of the writing instrument needs to make its diameter larger for providing a plurality of communication tubes in a case where communication tubes are attached directly to and integrally with the main body.

Still further, the use of a plurality of communication tubes with their tips inserted in the inner absorber (ink occlusion body) as described in the patent document 1 causes a problem of difficulty in reassembly after disassembly. Specifically, the problem is that the reassembly is difficult because the communication tubes each need to be positioned so as to be inserted into their initial positions in reassembly once the communication tubes are demounted from the inner absorber for part replacement, application liquid refill, or the like.

The present invention therefore aims to provide a no operating-type applicator being easily manufactured, having an enhanced strength of parts, and being capable of quickly writing at initial use (when ink is firstly supplied to an ink occlusion body from an ink tank).

### Solution to Problem

The invention according to claim 1 to solve the above-mentioned problem is an applicator including an application liquid reservoir in which filled application liquid is flowable, an applying body for applying the application liquid, an application liquid-occlusion body located between the application liquid reservoir and the applying body and designed to be impregnated with the application liquid, and a channel forming portion located between the application liquid reservoir and the occlusion body and having a channel in which the application liquid is flowable, wherein the channel forming portion has a protrusion, the protrusion protruding in a protruding direction toward the applying body and having a cavity and more than one communication openings communicated with the cavity.

This invention according to claim 1 has one protrusion (communication tube) located between the application liquid reservoir (ink tank) and the application liquid-occlusion body (inner absorber), the protrusion having a cavity therein and more than one communication openings communicated with the cavity.

This invention is provided with only one protrusion (communication tube) for connecting the application liquid reservoir and the application liquid-occlusion body. That gives higher degree of freedom in design of the communication tube than that in a case of formation of a plurality of communication tubes, allowing, for example, formation of a communication tube having a large diameter and a high strength. That enables to use such an ink that is difficult to be used via a communication tube having a small diameter (ink having high surface tension, for example), so that an applicator can use a wide variety of application liquids. Further, that has such an advantageous effect that the communication tube is durable and an accidental failure hardly occurs.

Further, compared with the case of formation of a plurality of communication tubes, a proximal end of the protrusion (communication tube) can be formed to have a small diameter. That enables to attach it to a main body having a smaller shaft diameter when the protrusion is formed separately from the main body and to make a shaft diameter of the main body smaller when the protrusion is formed integrally with the main body. In sum, the present invention has an advantageous effect that a shaft diameter of a main body of an applicator is made smaller.

Still further, the present invention has more than one communication openings communicated with the cavity, thereby discharging ink and introducing outside air through different openings respectively. That allows a quick exchange of ink with outside air in the application liquid reservoir.

The invention according to claim 2 is the applicator according to claim 1, the protrusion being in contact with the occlusion body.

In the present invention, the mouths of the openings of the protrusion can be arranged so as to be covered with the occlusion body since the protrusion (communication tube) is in contact with the occlusion body. By this arrangement, the application liquid is drawn by a capillary force of the occlusion body, whereby the flow rate per unit time of the application liquid from the communication tube is stabled. That is, that avoids flow of the application liquid being disrupted at the distal end of the communication tube by surface tension.

The invention according to claim 3 is the applicator according to claim 1 or 2, the communication openings including at least one communication opening located adjacent to a distal end of the protrusion and another communication opening located nearer to a proximal end of the protrusion than the at least one communication opening.

The present invention provides distance in the protruding direction of the protrusion (axial direction of the protrusion) between the communication opening located at the distal end and the other communication opening. Unlike the same distance between the communication openings in the protruding direction of the protrusion, the communication opening through which ink is supplied and the communication opening through which outside air is introduced are distantly positioned, so that outside air is more certainly introduced.

The invention according to claim 4 is the applicator according to one of claims 1 to 3, wherein the channel forming portion has a pressing portion, the pressing portion being at least partly in contact with the occlusion body from above.

In the present invention, the channel forming portion has the pressing portion, at least a part of which has contact with the occlusion body from above. The upper part of the occlusion body is pressed by the pressing portion, so that a part having a lower porosity is formed adjacent to the lower end of the occlusion body. Hence, the occlusion body has a low density part having a higher porosity adjacent to the upper end and a high density part having a lower porosity adjacent to the lower end. A density difference produced between the upper end part and the lower end part of the occlusion body in this way renders the capillary force of the occlusion body adjacent to the lower end stronger than that adjacent to the upper end.

By this arrangement, even if ink cannot flow downwardly only by its gravity as in cases of the ink having a high viscosity or the communication tube having an opening with a small diameter, the ink is drawn to the occlusion body by the capillary force and further downwardly without fail. Consequently, ink supply to the pen tip is further stabilized.

The invention according to claim 5 is the applicator according to claim 4, the pressing portion having a lower end positioned above the communication openings.

In this invention, the lower end of the pressing portion is positioned above the communication openings. Thus, the communication openings and the occlusion body are more certainly in contact with each other without preventing contact between the communication openings and the occlusion body by the pressing portion.

Specifically, in cases of the lower end of the pressing portion being below the communication openings or being on a level with the communication openings in a height direction, the pressing portion presses the occlusion body in a direction away from the protrusion, which might prevent contact between the communication openings formed in the protrusion and the occlusion body. However, in this invention, the pressing portion is positioned above the communication openings, so as not to prevent contact between the occlusion body and the communication openings located in the lower part of the protrusion.

The invention according to claim 6 is the applicator according to one of claims 1 to 5, wherein the channel forming portion includes a base and the protrusion, the base and the protrusion being of columnar shapes with different diameters and each having a cavity passing through its center part, and the communication openings being located at a circular face at a distal end of the protrusion and at a side face of and adjacent to the distal end of the protrusion.

This invention can provide the applicator having the protrusion (communication tube) being easily attached to the applicator body, being easily manufactured, and having an enhanced strength.

The invention according to claim 7 is the applicator according to claim 6, the pressing portion being a plate-like projection projecting outwardly from and substantially perpendicularly to the side face of the protrusion and extending from a proximal end to a vicinity of a distal end in the protruding direction of the protrusion, and the opening formed at the side face of and adjacent to the distal end of the protrusion having a central axis extending substantially in parallel with the projecting direction of the pressing portion.

This invention can provide the applicator having the pressing portion with an enhanced strength and having the protrusion (communication tube) being easily manufactured.

The invention according to claim 8 is the applicator according to one of claims 1 to 7, the occlusion body being partly arranged within the channel forming portion.

By this invention, a part of the occlusion body is arranged within the channel forming portion. That allows the ink to flow further downwardly by the capillary force of the occlusion body only when the ink is brought into contact with the occlusion body located within the channel forming portion even if the ink cannot flow downwardly to an outlet only by its gravity as in cases of the ink having a high viscosity or the protrusion having a small diameter. Consequently, the ink certainly flows to the occlusion body, so as to be stably supplied.

The invention according to claim 9 is the applicator according to one of claims 1 to 8, the channel forming portion and the application liquid reservoir being integrally formed.

By this invention, the channel forming portion and the application liquid reservoir are integrally formed, so that the application liquid is refilled only by exchange of the previous channel forming portion with a new channel forming portion in which the application liquid has been filled in the application liquid reservoir. That facilitates refilling work of the application liquid, compared with the use of another member such as a dropper for refilling the application liquid in the application liquid reservoir in the applicator body.

Further, reduced number of parts by the integral formation of the channel forming portion and the application liquid reservoir has also an advantageous effect of reduced manufacturing cost and simplified assembly.

The invention according to claim 10 is the applicator according to one of claims 1 to 8, the channel forming portion and the application liquid reservoir being attachable to and detachable from each other.

By this invention, the channel forming portion and the application liquid reservoir are attachable to and detachable from each other, so that only exchange of the application liquid reservoir enables refill of the application liquid. That facilitates refilling work of the application liquid, compared with the use of another member such as a dropper for refilling the application liquid in the application liquid reservoir in the applicator body.

The invention according to claim 11 is the applicator according to claim 10, the application liquid reservoir having a throughhole at its lower part, through which throughhole an internal space of the reservoir communicates with an outer space, and the channel forming portion including the base and the protrusion, the base having a tubular portion communicated with the cavity of the protrusion, so that the throughhole and the tubular portion are communicated with each other when the channel forming portion and the application liquid reservoir are attached to each other.

The configuration according to claim 11 further facilitates attachment and detachment of the channel forming portion and the application liquid reservoir.

### Advantageous Effects of Invention

The present invention has an advantageous effect of facilitating manufacturing and enhancing strength of parts. Further, the present invention is advantageously capable of writing quickly at initial use.

### BRIEF DESCRIPTION OF DRAWINGS

FIG. 1 is a cross section of an applicator of a first embodiment of the present invention;

FIG. 2 is a perspective view of an intermediate member used in the first embodiment of the present invention and placed upside down;

FIG. 3 is a cross section of the intermediate member taken along a line A-A of FIG. 2;

FIGS. 4A to 4D each are an explanatory diagram of the applicator of the first embodiment, showing that ink is being filled in an inner absorber arrangement portion in order of 4A to 4D;

FIGS. 5A to 5C each are an explanatory diagram showing a level of ink (water level) in the applicator of the first embodiment when ink filled in the inner absorber arrangement portion has reduced and is being filled again from the ink tank, FIG. 5A showing that the ink is filled in the inner absorber arrangement portion, FIG. 5B showing that the ink in the inner absorber arrangement portion has reduced, and FIG. 5C showing that the ink is filled in the inner absorber arrangement portion again;

FIGS. 6A to 6D each are an explanatory diagram of an applicator using an intermediate member of a second embodiment of the present invention, showing that ink is being filled in an inner absorber arrangement portion in order of 5A to 5D;

FIG. 7 is a cross section of an applicator of a third embodiment of the present invention;

FIG. 8 is a perspective view of an intermediate member of a fourth embodiment of the present invention;

FIG. 9 is a perspective view of an intermediate member having a protrusion of a fifth embodiment of the present invention;

FIG. 10 is a perspective view of an intermediate member having a protrusion of a sixth embodiment of the present invention;

FIG. 11 is a perspective view of an intermediate member having a protrusion of a seventh embodiment of the present invention;

FIGS. 12A to 12M each are an explanatory diagram of a mouth shape of an opening formed in an intermediate member different from that of the embodiment in FIG. 2;

FIG. 13 is a cross section of an applicator of an eighth embodiment of the present invention;

FIG. 14 is a perspective view of an intermediate member used in the eighth embodiment of the present invention and placed upside down;

FIG. 15 is a plan view of the intermediate member seen from a direction A of FIG. 14;

FIG. 16 is a cross section of the intermediate member taken along a line B-B of FIG. 14;

FIG. 17 is a perspective view of an ink tank section used in the eighth embodiment of the present invention;

FIG. 18 is a cross section of the ink tank section taken along a line A-A of FIG. 17;

FIG. 19 is a cross section of the applicator, without ink therein, of the eighth embodiment of the present invention;

FIGS. 20A and 20B each are an explanatory diagram showing the intermediate member and the ink tank section in FIG. 13 being connected with each other with the intermediate member partly broken, the connection being performed in order of 20A to 20B;

FIGS. 21A to 21D each are an explanatory diagram of the applicator of the eighth embodiment, showing that ink is being filled in an inner absorber arrangement portion in order of 20A to 20D;

FIGS. 22A to 22C each are an explanatory diagram showing a level of ink (water level) in the applicator of the eight embodiment when ink filled in the inner absorber arrangement portion has reduced and is being filled again from the ink tank, FIG. 22A showing that the ink is filled in the inner absorber arrangement portion, FIG. 22B showing that the ink in the inner absorber arrangement portion has reduced, and FIG. 22C showing that the ink is filled in the inner absorber arrangement portion again;

FIG. 23 is a perspective view of an intermediate member of a ninth embodiment of the present invention; and

FIG. 24 is a perspective view of an intermediate member of a tenth embodiment of the present invention.

### BEST MODE FOR EMBODYING THE INVENTION

Now, embodiments of the present invention will be described in detail below, making reference to the accompanying drawings. Herein, as to an anteroposterior relationship in the description below, a side near a pen tip is designated as a front side and a side near an ink tank is designated as a rear side.

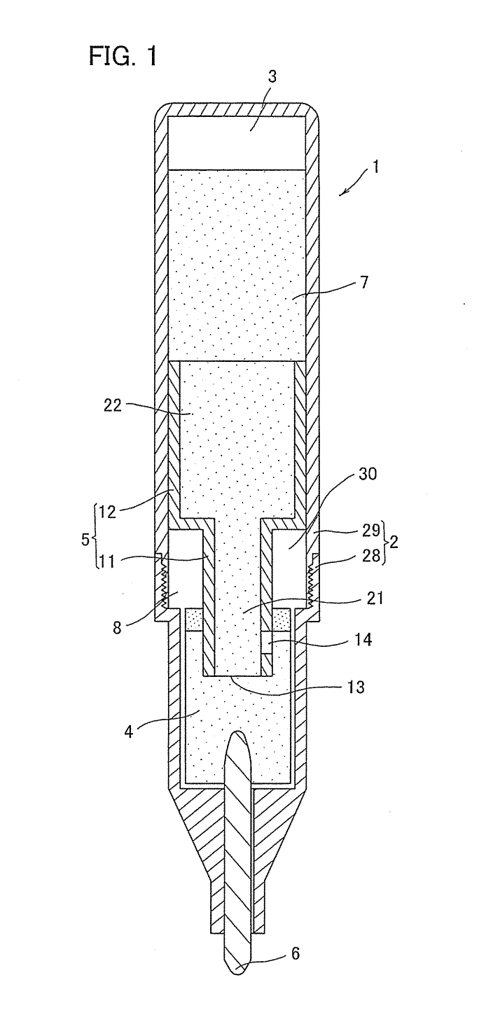

An applicator 1 of a first embodiment of the present invention is specifically a whiteboard marker and mainly consists of, as shown in FIG. 1, a main body tube 2, an inner absorber (application liquid-occlusion body) 4, an intermediate member (channel forming portion) 5, a pen tip (applying body) 6. The main body tube 2 has an inner space divided into a front portion and a rear portion by the intermediate member 5. The rear portion includes an ink tank (application liquid reservoir) 3 designed to store ink (application liquid) 7 and the front portion includes an inner absorber arrangement portion 8.

The main body tube 2 is a tubular body made of a proper material such as resin like polypropylene or metal like niobium. The main body tube 2 is composed of a distal portion 28 and a proximal portion 29, which are attachably to and detachably from each other by a screw. The distal portion 28 tapers off to a point in appearance. Additionally, the distal portion 28 has therein a space 30 extending in a longitudinal direction and also tapering off to a point.

The inner absorber 4 is the known inner absorber, being a member having continuous pores for being impregnated with the ink 7. Specifically, the inner absorber 4 is made of proper fiber such as acrylic fiber and adapted to be impregnated with the ink 7 therein.

The intermediate member 5 is a characteristic component of the present embodiment and will be described in detail below.

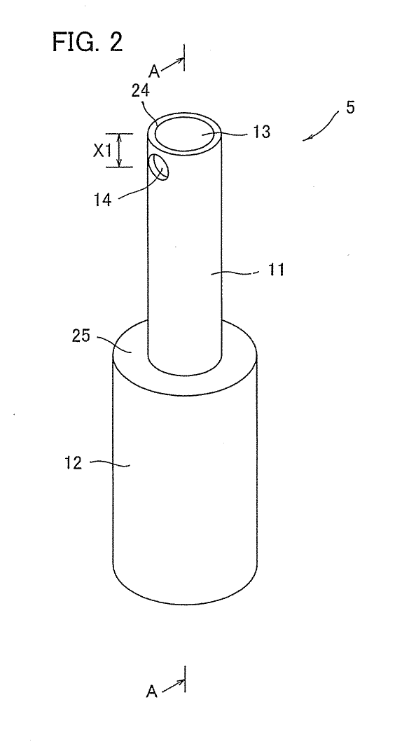

The intermediate member 5 is made of a proper material such as synthetic resin like polypropylene or polyacetal and metal. As shown in FIG. 2, the intermediate member 5 mainly consists of a protrusion 11 and a base 12. The protrusion 11 and the base 12 each are of a columnar shape in appearance, the protrusion 11 having a diameter smaller than that of the base 12. The protrusion 11 and the base 12 are contiguous end to end with a step in such a manner that two columns are stacked on the same central axes. Specifically, a face 25 perpendicular to a longitudinal direction of the base 12 (a top face in FIG. 2) is joined with a face of a proximal end of the protrusion 11.

In short, the intermediate member 5 is formed as two stacked columns in appearance with the protrusion 11 protruding from a central part of the face 25 of the base 12. Herein, the protrusion 11 protrudes in a direction perpendicular to the face 25 of the base 12.

Further, the protrusion 11 has a first opening (communication opening) 13 and a second opening (communication opening) 14.

The first opening 13 is arranged at a circular face 24 at a distal end in the protruding direction of the protrusion 11 (top face in FIG. 2 and face opposed to the face contacting with the base 12). The first opening 13 has a circular mouth shape, whose center overlaps the central axis of the protrusion 11. The first opening 13 has a diameter not particularly limited, but preferably of 2 mm to 7 mm, more preferably of 2.5 mm to 3.0 mm, and most preferably of 3.0 mm. The mouth of the first opening 13 has an area preferably of 3.14 mm² (square millimeter) to 38.47 mm² (square millimeter) and more preferably of 4.9 mm² (square millimeter) to 7.07 mm² (square millimeter).

The second opening 14 is arranged at a side face of the protrusion 11 and more specifically adjacent to the distal end in the protruding direction of the protrusion 11 (end part opposed to the base 12). The second opening 14 also has a circular mouth shape as well as the first opening 13. The second opening 14 has a diameter not particularly limited but preferably of 1.0 mm to 5.0 mm and more preferably of 1.0 mm. The mouth of the second opening 14 has an area preferably of 0.79 mm² (square millimeter) to 19.63 mm² (square millimeter) and more preferably of 0.79 mm² (square millimeter) to 7.07 mm² (square millimeter). Besides, a distance from the distal end of the protrusion 11 to the center of the second opening (X1 in FIG. 2) is not also particularly limited, but preferably of 2.0 mm to 7.0 mm and more preferably of 3.0 mm.

Herein, the second opening 14 is situated at the side face of the protrusion 11, so that the first opening 13 and the second opening 14 open in a direction perpendicular to each other. Further, the second opening 14 is situated near the distal end in the protruding direction of the protrusion 11, so that the first opening 13 and the second opening 14 are positioned near each other in the protruding direction of the protrusion 11 (axial direction of the protrusion 11).

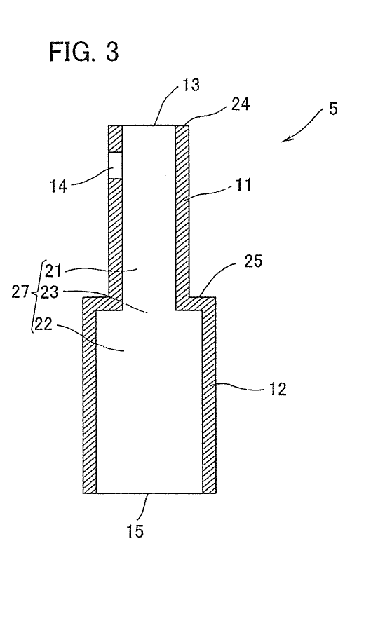

Now, an internal configuration of the intermediate member 5 will be described below. As shown in FIG. 3, the protrusion 11 and the base 12 have cavities 21 and 22 respectively therein.

The cavity 21 is a cavity extending in a circular cross section and specifically passing through the center of the protrusion 11 in parallel to a longitudinal direction from its end face near the base 12 toward the first opening 13 so as to communicate with the first opening 13. The first opening 13 and the cavity 21 have cross-sections with the same diameters and centers located at the same location. In other words, the protrusion 11 is of a substantially hollow cylinder with the cavity 21 and the first opening 13 passing through its central part. Further, the cavity 21 is communicated with and intersects perpendicularly with the second opening 14. In sum, the cavity 21 is communicated with outside through the first opening 13 and the second opening 14.

The cavity 22 is also a cavity extending in a circular cross section and passing through the center of the base 12 in parallel to the longitudinal direction. The cavity 22 has a cross-section diameter larger than that of the cavity 21. Herein, the base 12 has an opening 15 with a circular mouth shape at its proximal end opposed to the protrusion 11 (lower end in FIGS. 2 and 3). The cavity 22 is communicated with outside through the opening 15. The opening 15 and the cavity 22 have the same cross-section diameters. In sum, the cavity 22 extends from the opening 15 to a vicinity of a distal end opposed to the opening 15 (upper end in FIGS. 2 and 3), so that the base 12 is of a substantially based hollow cylinder.

The cavity 21 and the cavity 22 are communicated with each other through a connecting hole 23. Specifically, the connecting hole 23 passing through the base 12 from inside to outside is formed at the distal end opposed to the opening 15 of the base 12. The connecting hole 23 has a circular cross section with the same cross section diameter and central axis as those of the cavity 21. In short, the cavity 21 and the connecting hole 23 overlap so as to form almost one throughhole.

Consequently, the intermediate member 5 is shaped like two pipes having different diameters and connected via a step and has the opening communicated with inside at the distal end of the side face of the pipe having a smaller diameter. The intermediate member 5 has an internal space (internal opening) 27 formed therein. The internal space 27 is a cavity formed by integrating the cavity 21 of the protrusion 11, the cavity 22 of the base 12, and the connecting hole 23 between the cavities 21 and 22. The internal space 27 is formed by hollowing out the inside of the intermediate member 5, so as to have a total shape similar to an appearance configuration of the intermediate member 5. The internal space 27 is communicated with the outside through the opening 15, the first opening 13, and the second opening 14. In sum, the internal space 27 passes through the both ends of the intermediate member 5 in the longitudinal direction.

The pen tip 6 is, similar to the known pen tip, formed by a material combining proper fiber bundle, such as a thermal fusion bonded body of fiber bundle, a resonated body of fiber bundle, and a resonated body of felt and functions to absorb the ink 7 from the inner absorber 4 by capillary action.

Now, an assembly structure of the applicator 1 of the present embodiment will be described below, making reference to FIG. 1.

The intermediate member 5 is inserted in the proximal portion 29 of the main body tube 2. The inner diameter of the proximal portion 29 and the outer diameter of the base 12 of the intermediate member 5 are substantially the same, so that the intermediate member 5 is introduced into the proximal portion 29 and fixed thereto. Herein, the rear part of the proximal portion 29 located posterior to the intermediate member 5 serves as the ink tank 3, in which the ink 7 is contained.

The pen tip 6 is attached to an anterior end of the distal portion 28. The inner absorber 4 is arranged within the space 30 and posterior to the pen tip 6. The ink 7 is filled in the ink tank 3 and the distal portion 28 is attached to the proximal portion 29, and whereby the applicator 1 is assembled.

In this situation, the inside of the main body tube 2 is divided into the front portion and the rear portion by the intermediate member 5. In the main body tube 2, the front portion serves as the inner absorber arrangement portion 8. In short, the base 12 of the intermediate member 5 serves as a partition between the ink tank 3 and the inner absorber arrangement portion 8, and the protrusion 11 and the cavity 21 of the protrusion 11 serves as a communication tube connecting the ink tank 3 with the inner absorber arrangement portion 8.

The inner absorber 4 is arranged at the inner absorber arrangement portion 8. The inner absorber 4 contacts with a proximal end of the pen tip 6 and the distal end of the protrusion 11 of the intermediate member 5 (tip in the protruding direction), so as to cover the first opening 13 and the second opening 14.

Herein, a part of a rear end of the inner absorber 4 may enter the cavity 21 of the protrusion 11 through the first opening 13 or the second opening 14. Specifically, the inner absorber 4 may be partly situated within the protrusion 11 through the mouth of the first opening 13 and/or the mouth of the second opening 14.

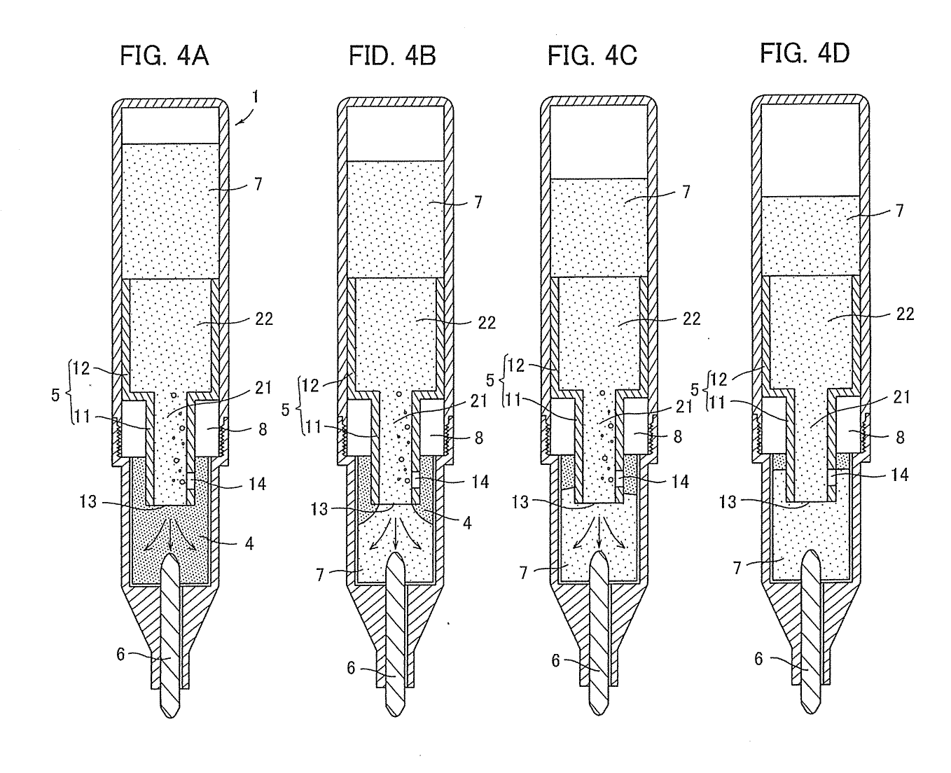

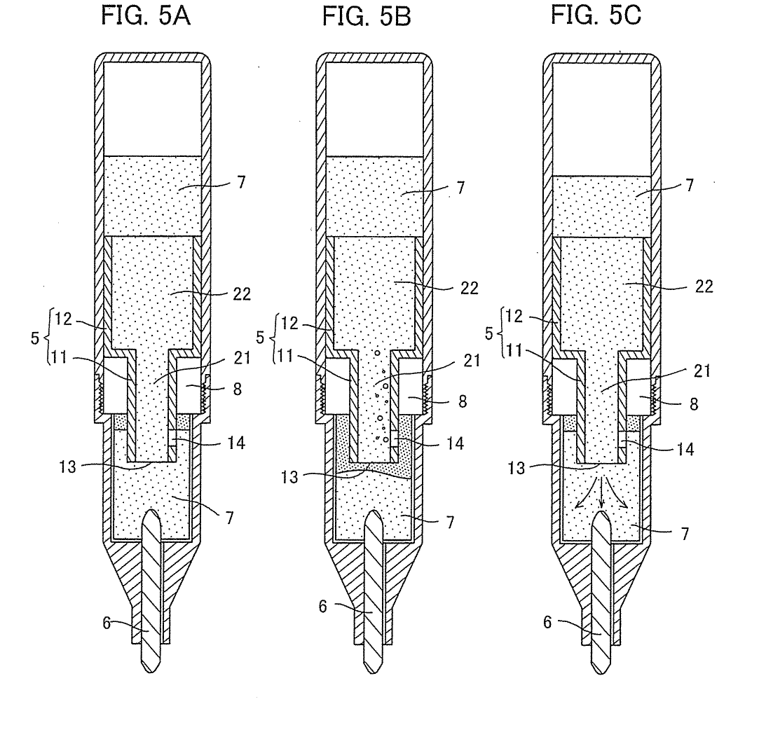

Now, a function of the applicator 1 of the present embodiment will be described in detail below, making reference to FIGS. 4A to 5C.

The pen tip 6 being headed downwardly for writing, the ink 7 flows from the ink tank 3 through the intermediate member 5 to the inner absorber arrangement portion 8 by gravity as shown in FIG. 4A. The ink 7 having flowed adjacent to the distal end of the protrusion 11 of the intermediate member 5 is further drawn downwardly by its own gravity and a capillary force of the inner absorber 4. That supplies the ink 7 to the inner absorber arrangement portion 8 through the first opening 13. At this time, outside air (slight amount of air) is introduced into the ink tank 3 through the second opening 14 lying unused for supply of the ink 7. The ink 7 and the outside air are exchanged within the ink tank 3, so that the ink 7 is roundly supplied to the inner absorber arrangement portion 8 through the first opening 13. Herein, the second opening 14 is located nearer to the ink tank 3 than the first opening 13 and above the first opening 13 when the pen tip 6 is headed downwardly. Therefore, the ink 7 is supplied through the first opening 13 having a high water pressure to the inner absorber arrangement portion 8, so as not to be supplied through the second opening 14.

The ink 7 can have a preferable flow rate by making the diameters and/or areas of the first opening 13 and the second opening 14 to be the above-mentioned preferable sizes and by arranging the distance of the second opening 14 from the distal end of the protrusion to be the above-mentioned preferable length. That stably supplies the ink 7 to the inner absorber arrangement portion 8.

The ink 7 continues to be supplied to the inner absorber arrangement portion 8, so that the inner absorber 4 is being impregnated with the ink 7 as shown in FIG. 4B. At this time, the first opening 13 and the inner absorber 4 are in contact with each other, so that the ink 7 having approached the first opening 13 is drawn by the capillary force of the inner absorber 4. That avoids flow of the ink 7 being disrupted around the first opening 13 by surface tension.

As the inner absorber 4 is being impregnated with the ink 7, a level of the ink 7 in the inner absorber arrangement portion 8 is rising (a border line of the level is approaching the ink tank 3). The level of the ink 7 in the inner absorber arrangement portion 8 eventually reaches a level (position) of the first opening 13, then rising above the level of the first opening 13 (position near the ink tank 3) as shown in FIG. 4C.

As the level of the ink 7 in the inner absorber arrangement portion 8 rises in this way, the inner absorber arrangement portion 8 is eventually filled with the ink 7 to the level of the second opening 14 as shown in FIG. 4D. That gets the second opening 14 into liquid seal by the impregnated ink 7, thereby substantially sealing the second opening 14. Then, outside air is unable to be introduced into the ink tank 3, which stops supplying the ink 7 to the inner absorber arrangement portion 8. At this time, the inner absorber 4 is sufficiently impregnated with the ink 7 at its front part (lower part in FIGS. 4A to 5C), while the inner absorber 4 is insufficiently impregnated with the ink 7 at its rear part (upper part in FIGS. 4A to 5C). Herein, the rear part of the inner absorber 4 is normally impregnated with the ink 7, but unless surrounding temperature has increased.

Continuation of writing, with the front part of the inner absorber 4 impregnated with the ink 7 as shown in FIG. 5A, gradually reduces the ink 7 impregnated in the inner absorber 4 and then, as shown in FIG. 5B, the liquid seal of the second opening 14 is released. Then, outside air is roundly introduced into the ink tank 3 again, so that the ink 7 is started to be supplied to the inner absorber arrangement portion 8. The ink 7 is supplied to the inner absorber arrangement portion 8 until the impregnated ink 7 gets the second opening 14 into liquid seal again, as shown in FIG. 5C. As described above, in every reduction of the ink 7 as writing, the ink 7 is supplied to the inner absorber arrangement portion 8 and the inner absorber 4, so as to be stably supplied to the pen tip 6.

In the above-mentioned first embodiment, the ink tank 3 is defined by the main body tube 2 and the intermediate member 5, but the ink tank 3 is not necessarily limited thereto.

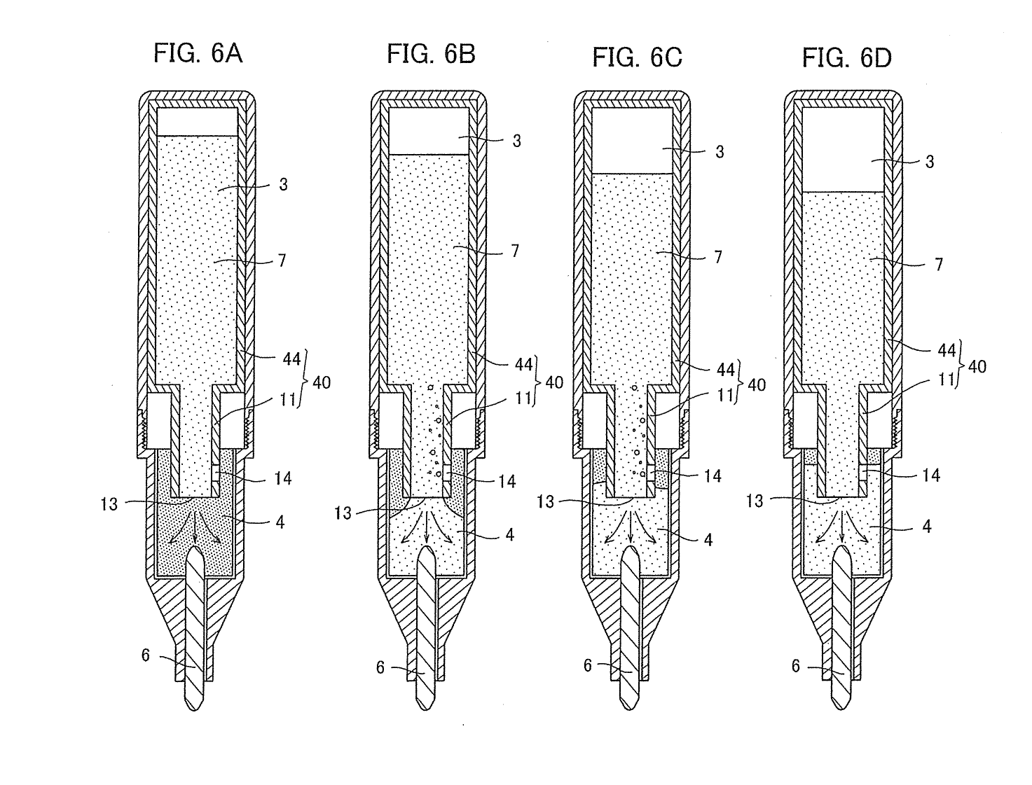

A second embodiment as shown in FIGS. 6A to 6D, for example, may have an intermediate member 40 formed by the intermediate member 5 with the opening 15 at the proximal end closed, so as to use a base 44 of the intermediate member 40 as the ink tank 3. The inner absorber 4 in this case is also impregnated with the ink 7 as shown in FIGS. 6A to 6D as well as in the above-mentioned embodiment.

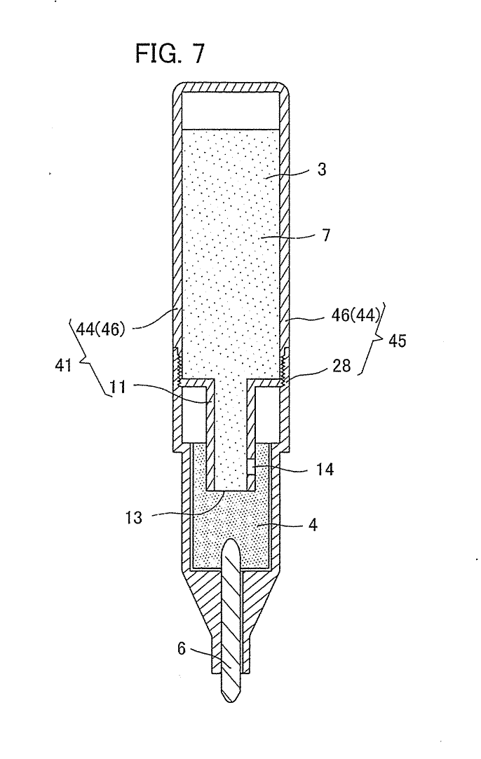

Alternatively, a third embodiment as shown in FIG. 7 may integrate a rear portion 46 of a main body tube 45 with the protrusion 11 so as to form an intermediate member 41 using the rear portion 46 of the main body tube 45 and a base 44 of the intermediate member 41 as one member, the base (rear portion 46 of the main body tube 45) 44 of the intermediate member 41 being used as the ink tank 3.

When an applicator is refilled with ink in such a manner as shown in the second and third embodiments, the ink 7 is refilled only by exchange of the intermediate member 40 or 41 with a new intermediate member 40 or 41 having been previously impregnated with the ink 7. That ensures such an advantageous effect as facilitating refill of the ink 7.

The above-mentioned embodiments each illustrate an example, in which the applicator 1 is a marker, but the present invention is not limited thereto and may be used in an applicator such as a fountain pen, a ballpoint pen, and a correction liquid applicator. Consequently, the main body tube 2 may be appropriately modified in material and shape.

Further, the pen tip 6 is formed by a material such as a resonated body of fiber bundle, a heat-sealed body of fiber bundle, a felt body, a pipy pen body, a fountain pen-shaped plate-like pen body having a tip with a slit, a calligraphy-brush pen, a porous foam body of synthetic resin, a ballpoint pen tip, a synthetic resin extrusion molding body having an ink pilot channel in an axial direction and an opened tip may be appropriately modified in material and shape.

Still further, the inner absorber 4 is, as described above, only necessary to be a member having continuous pores for being impregnated with the ink 7 and its shape is not limited to a substantially rectangular shape. Its material and shape may be appropriately modified. Besides, the inner absorber 4 may be regularly overall or irregularly in density. Formation of a high density part and a low density part in the inner absorber 4 makes it harder for the ink 7 to flow from the high density part to the low density part, thereby facilitating adjustment of an amount of the ink 7 to be supplied to the pen tip 6.

The above-mentioned embodiments each illustrate an example, in which the intermediate member 5 contacts with the inner absorber 4, but the intermediate member 5 and the inner absorber 4 are not necessarily to contact with each other. However, the intermediate member 5 (first and second openings) and the inner absorber 4 being out of contact, an amount of flow of the ink 7 per unit time might be reduced in supplying the ink 7 to the inner absorber arrangement portion 8 because the ink 7 is likely to remain in the cavity 21 due to surface tension acting on the ink 7 over gravity if the inner diameter of the intermediate member 5 is small. In contrast, the intermediate member 5 and the inner absorber 4 being in contact, a capillary force of the inner absorber 4 draws and smoothly flows the ink 7, thereby stabilizing an amount of flow of the ink 7 per unit time even if the inner diameter of the intermediate member 5 is designed small. Consequently, the intermediate member 5 and the inner absorber 4 are preferably in contact with each other in this way.

Further, the above-mentioned embodiments each illustrate an example, in which all the openings (first and second openings 13 and 14) formed in the protrusion 11 are covered (in contact) with the inner absorber 4, but both the first and second openings 13 and 14 are not necessarily in contact with the inner absorber 4. Only the first opening 13 can be in contact with the inner absorber 4 by bringing the protrusion 11 into contact with the rectangular inner absorber 4 from a side of the application liquid reservoir 3, for example. Alternatively, only the second opening 14 can be in contact with the inner absorber 4 by such a means as formation of a recess in the inner absorber 4 so that the first opening 13 is out of contact with the inner absorber 4. These may be appropriately modified depending on a viscosity of the ink 7, positions of the first and second openings 13 and 14, or the like. However, both the first and second openings 13 and 14 are preferably in contact with the inner absorber 4 because modification in this way might cause such a problem as overflowing of ink from the inner absorber arrangement portion 8.

In the above-mentioned embodiments, the diameter of the first opening 13 and that (length in a shorter direction) of the cavity 21 are the same, but are not necessarily to be the same, that is, can be different. The diameter of the cavity 21 can be larger or smaller than that of the first opening 13.

In the above-mentioned embodiments, the protrusion 11 has the first opening 13 formed at the circular face at the distal end in the protruding direction and the second opening 14 formed adjacent to the distal end at the side face, but the positions of these openings formed in the protrusion 11 are not limited to the distal end.

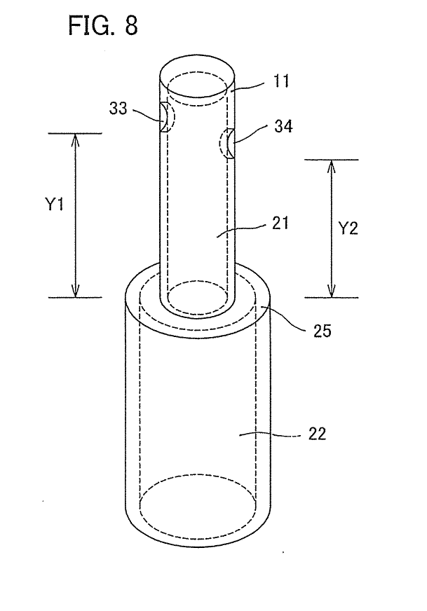

As in a fourth embodiment shown in FIG. 8, for example, both a first opening 33 and a second opening 34 can be formed at a side face. At this time, these openings (first and second openings 33 and 34) can be arranged at the same position or away from each other in an axial direction of the protrusion 11. Specifically, when a distance from the face 25 at the proximal end in the protruding direction of the protrusion 11 to the first opening 33 is designated as Y1 and a distance from the face 25 to the second opening 34 is designated as Y2, Y1 and Y2 can be equal or either Y1 or Y2 can be longer. However, if Y1 and Y2 are equal, outside air is difficult to be introduced into the application liquid reservoir 3, resulting in necessity of enlargement of the diameters of the first and second openings 33 and 34. Since that causes a problem such as lowered intensity, the first and second openings 33 and 34 are preferably separated from each other in the axial direction of the protrusion 11.

The above-mentioned embodiments each illustrate an example, in which the protrusion 11 is of a cylindrical shape, but a shape of the protrusion is not limited thereto. Besides, the number of openings formed in the protrusion 11 is not limited to two and may be more than two.

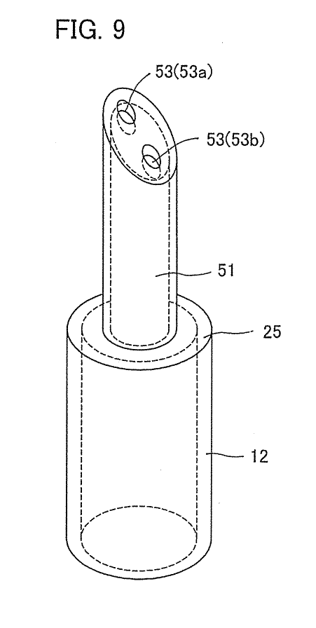

As shown in a fifth embodiment in FIG. 9, for example, a protrusion 51 can be of a columnar shape with its distal end cut obliquely. Further, there may be provided two openings 53 in a circular face at the distal end. Since the circular face formed at the distal end of the columnar shape leans toward a protruding direction of the protrusion 51, each part differs in position in the protruding direction (in distance from the proximal end (face 25)). Thus, the opening 53 (53a) far from the proximal end can serve as the above-mentioned first opening 13, while the opening 53 (53b) near the proximal end can serve as the above-mentioned second opening 14.

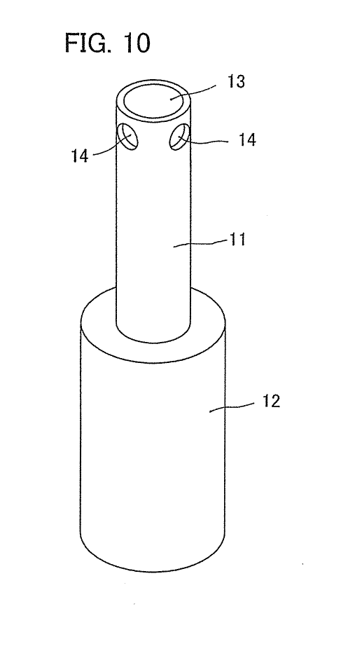

Alternatively, as shown in a sixth embodiment in FIG. 10, the protrusion 11 may have a plurality of second openings 14 at its side face.

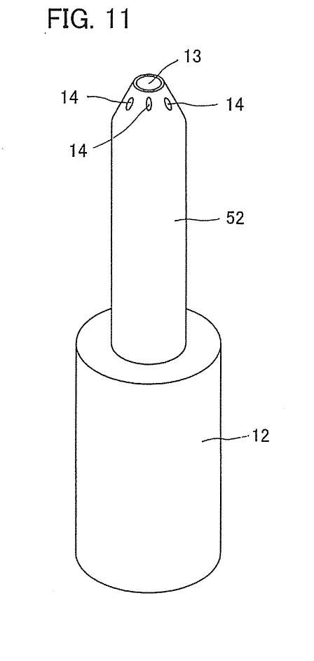

Alternatively, as shown in a seventh embodiment in FIG. 11, a protrusion 52 can be of a conical shape with its tip cut off. The protrusion 52 has the first opening 13 in a circular face at the distal end and a plurality of second openings 14 in a face tapering toward the distal end.

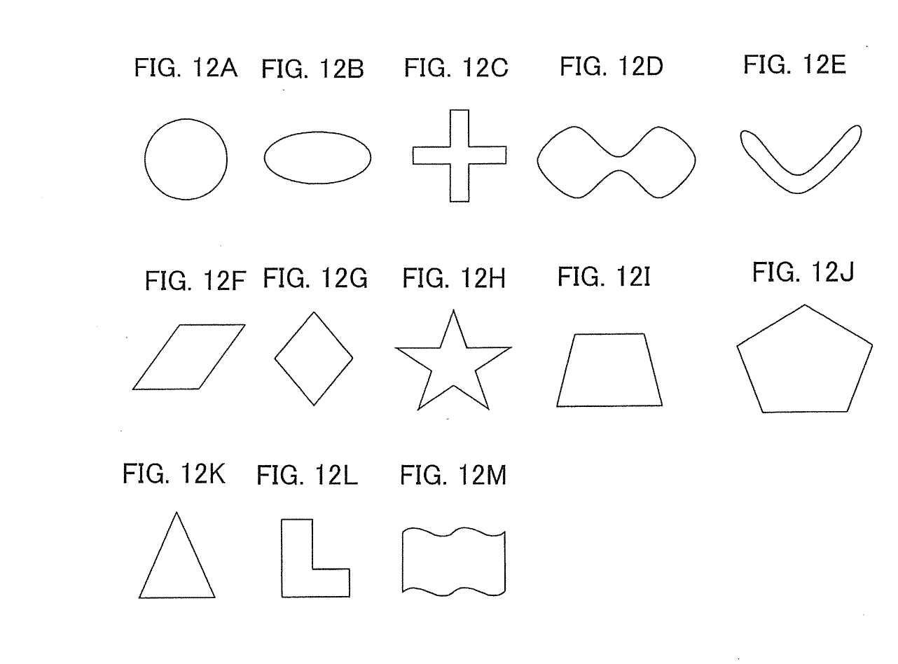

In the above-mentioned embodiments, the first and second openings 13 and 14 each are of a circular mouth shape, but are not necessarily of a circular opening shape. Referring to FIGS. 12A to 12M, mouth shapes of the openings will be described below. The mouth of the opening formed in the protrusion 11 is not only of a circular shape (A) but may be also of an ellipsoidal shape (B). Alternatively, it may be shaped like a combined ellipsoidal or polygonal shape such as a cross shape (C) with two rectangles lapped, a gourd shape (D) with two substantially circular openings lapped, a so-called boomerang shape (E) of a substantially v shape. Alternatively, it may be of a polygonal shape such as a parallelogram (F), a diamond shape (G), a trapezoid (I), a pentagon (J), or a triangle (K). Alternatively, it may be of a star (H), an “L” shape, or a polygonal shape (M) partly having wavy curve. The mouth shape of the opening formed in the protrusion can be appropriately modified in this way. However, the opening having a circular mouth shape is easily processed, so as to be preferable in manufacturing.

Further, unlike the above-mentioned embodiments, the first opening 13 and the second opening 14 do not necessarily have the same mouth shapes and may have different mouth shapes. The same can be said in a case of more than two openings formed in the protrusion. The openings may have different mouth shapes or the same mouth shapes. The mouth shapes of the openings formed in the protrusion can be combined in discretion.

Now, an eighth embodiment of the present invention will be described below. Herein, the same numerals are assigned to the same members as those in the above-mentioned first embodiment, so as to eliminate duplicated description.

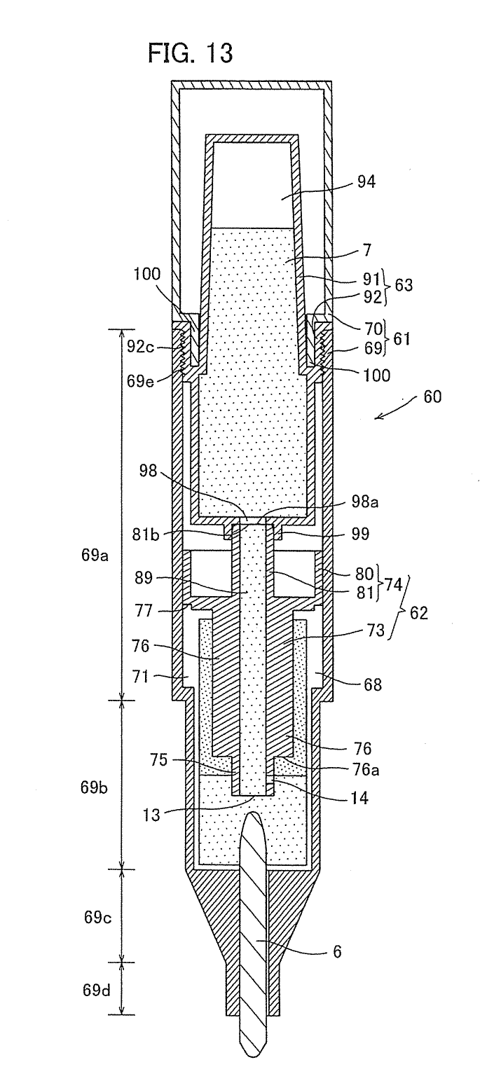

An applicator 60 in the eighth embodiment, as shown in FIG. 13, mainly consists of a main body tube 61, an intermediate member (channel forming portion) 62, and an ink tank section (application liquid reservoir) 63. The main body tube 61 has the ink tank section 63 for storing the ink 7 arranged at a rear portion in its inner space and an inner absorber arrangement portion 68 arranged at a front portion in its inner space. The inner space of the main body tube 61 is divided into the front portion and the rear portion by the intermediate member 62.

The main body tube 61 mainly consists of a distal portion 69 and a proximal portion 70. The distal portion 69 is tapered toward a distal end in appearance. Specifically, there are provided a large diameter tubular portion 69a, a small diameter tubular portion 69b, a tapered portion 69c, and a smallest diameter tubular portion 69d formed continuously from a proximal end toward the distal end. The large diameter tubular portion 69a and the small diameter tubular portion 69b are continuous via a step. The distal portion 69 further has therein an internal space 71 communicating in a longitudinal direction. The internal space 71 is also tapered toward the distal end. The distal portion 69 is provided with a main body-helical groove 69e at the proximal end of its inner periphery.

The proximal portion 70 is a lid body of a substantially based cylindrical shape with an opening at one end.

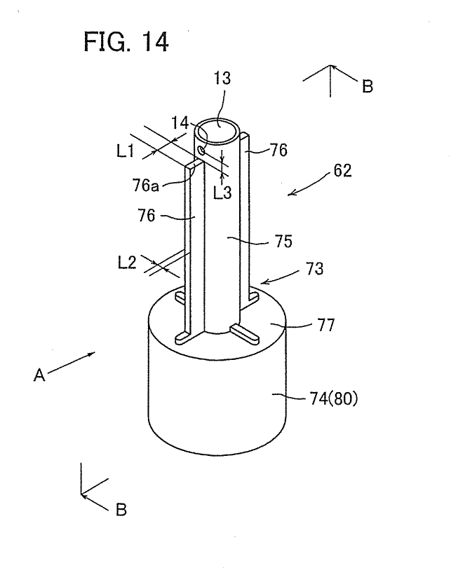

The intermediate member 62 is made of a proper material such as synthetic resin like polypropylene or polyacetal and metal. As shown in FIG. 14, the intermediate member 62 mainly consists of a protrusion 73 and a base 74.

The protrusion 73 is formed by a protrusion body 75 of a cylindrical shape and pressing pieces (pressing portions) 76 of a rectangular flat plate. The protrusion body 75 protrudes substantially vertically and forward (upward in FIG. 14) from a distal face (upper face in FIG. 14) 77 of the base 74. The pressing pieces 76 are arranged at two locations shifted at substantially 180 degrees in a circumferential direction of a side face of the protrusion body 73 and projecting outward from the side face of the protrusion body 75. Herein, both the pressing pieces 76 project in a direction substantially perpendicular to a longitudinal direction (protruding direction) of the protrusion body 75. Therefore, the pressing pieces 76 project in a direction away from each other. The pressing pieces 76 extend along the longitudinal direction of the protrusion body 75. Specifically, proximal ends of the pressing pieces 76 each have contact with the distal face 77 of the base 74, while distal ends thereof each are situated slightly behind (at a lower side in FIG. 14) the distal end (distal end in the protruding direction and upper end in FIG. 14) of the protrusion body 75. In short, the pressing pieces 76 each project substantially perpendicularly to and forward (upward in FIG. 14) from the distal face (upper face in FIG. 14) 77 of the base 74 and have a length in the longitudinal direction slightly shorter than the protrusion body 75.

Herein, a width L1 of each of the pressing pieces 76, or a length L1 in the projecting direction of each of the pressing pieces 76 is not particularly limited, but preferably of 2.0 mm to 4.5 mm and more preferably of 4.0 mm.

Additionally, a thickness L2 of each of the pressing pieces 76, or a length L2 of each of the pressing pieces 76 in a direction substantially perpendicular to the longitudinal (extending) and projecting direction is not particularly limited, but preferably of 1.0 mm to 3.0 mm and more preferably of 1.5 mm.

The protrusion 73 of the present embodiment is shaped like the protrusion 11 of the above-mentioned first embodiment with the pressing pieces 76 attached. In other words, the protrusion body 75 of this embodiment and the protrusion 11 of the first embodiment have substantially the same shape, so that the protrusion body 75 of this embodiment has the first opening 13 and the second opening 14 as well as the protrusion 11 of the first embodiment. Thus, duplicated description as to the first and second openings 13 and 14 is omitted.

Herein, the second opening 14 of this embodiment is, as shown in FIG. 14, disposed at substantially the same position as one of the pressing pieces 76 in a circumferential direction of the protrusion body 75. The second opening 14 is positioned slightly forward (upward in FIG. 14) than the distal end face (upper end face in FIG. 14) 76a of the pressing piece 76. Therefore, the distal end face (upper end face in FIG. 14) 76a of the pressing piece 76 is situated near the back of (under in FIG. 14) the second opening 14. Actually, as shown in FIG. 13, the distal end face (lower end face) 76a of the pressing piece 76 is situated above the second opening 14 and the second opening 14 and the distal end face 76a (lower end face) of the pressing piece 76 are closely situated.

Herein, a distance L3 from the distal end face 76a of the pressing piece 76 to the center of the second opening 14 is not particularly limited, but preferably of 0.5 mm to 3.0 mm and more preferably of 1.0 mm.

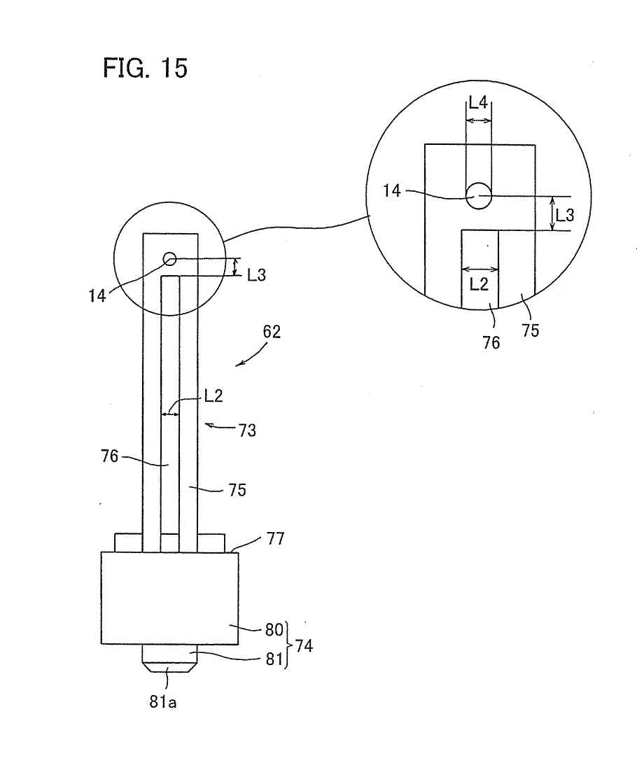

Further, in this embodiment, as shown in FIG. 15, the length L2 in the thickness direction of the pressing piece 76 is longer than a diameter L4 of the second opening 14. In this way, the thickness L2 of the pressing piece 76 is preferably longer than the diameter L4 of the second opening 14.

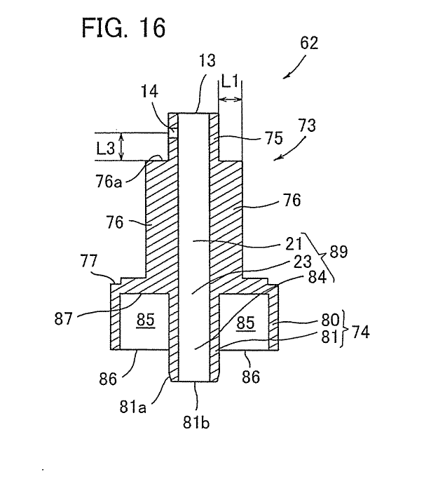

The base 74, as shown in FIGS. 14 and 15, mainly consists of an outer tube 80 and an inner tube 81 located on the inner side of the outer tube 80. The outer tube 80 is, as shown in FIGS. 14 to 16, is of a substantially based cylindrical shape with an opening 86 at one side. The inner tube 81 is of a substantially cylindrical shape. Besides, the inner tube 81 is smaller in diameter than the outer tube 80 and located in a central part of the outer tube 80. The inner tube 81 and the outer tube 80 have the same central axes and are tubular bodies extending in a longitudinal direction (vertical direction in FIGS. 15 and 16).

Referring to FIG. 16, the inner tube 81 has a distal portion connected to an inside bottom 87 of the outer tube 80 and a proximal portion projecting behind (below in FIGS. 15 and 16) a proximal end (lower end in FIGS. 15 and 16) of the outer tube 80. The inner tube 81 is longer than the outer tube 80 in a longitudinal direction (vertical direction in FIG. 16).

The inner tube 81 has at its proximal end a tapered portion 81a with an outer periphery decreasing in diameter backward.

Now, an internal configuration of the intermediate member 62 will be described in detail below.

Referring to FIG. 16, the intermediate member 62 has cavities 21, 84, and 85 inside the protrusion 73 and the base 74, respectively.

The cavity 21 is formed inside the protrusion body 75 in the protrusion 73. The cavity 21 is substantially the same as the cavity 21 formed inside the protrusion 11 of the above-mentioned first embodiment, and thus detailed description is omitted.

In the base 74, the cavity 84 is formed inside the inner tube 81 and the annular cavity 85 is formed in between the outer periphery of the inner tube 81 and an inner periphery of the outer tube 80.

The cavity 84 formed inside the inner tube 81 is a space having a circular cross section and extending in a longitudinal direction of the inner tube 81.

The cavity 21 of the protrusion body 75 and the cavity 84 of the inner tube 81 are continuous via a connecting hole 23. The connecting hole 23 is a throughhole penetrating a bottom part opposed to the opening 86 of the base 74 from within outward and extending in a penetrating direction in a circular cross section.

The connecting hole 23 and the cavity 21 of the protrusion body 75 are holes extending in a circular cross section and having the same cross-sectional diameter, the same extending direction, and the same central axis. The connecting hole 23 and the cavity 21 of the protrusion body 75 form one throughhole by overlapping. Consequently, an inner periphery of the cavity 21 of the protrusion body 75 and that of the connecting hole 23 have the same surface.

Further, the connecting hole 23 and the cavity 84 of the inner tube 81 are also holes extending in a circular cross section and having the same cross-sectional diameter, the same extending direction, and the same central axis. The connecting hole 23 and the cavity 84 of the inner tube 81 form one throughhole by overlapping. Consequently, an inner periphery of the cavity 84 of the inner tube 81 and that of the connecting hole 23 have the same surface.

In short, the intermediate member 62 has inside an internal space (internal opening) 89 formed integrally by the cavity 21 of the protrusion body 75, the connecting hole 23, and the cavity 84 of the inner tube 81.

The internal space 89 is a throughhole penetrating from an opening 81b formed at a proximal end of the cavity 84 in the inner tube 81 to the mouth of the first opening 13 formed in the protrusion body 75. The internal space 89 has a circular cross section and the substantially same diameter and extends in a longitudinal direction of the intermediate member 62. The opening 81b formed at the proximal end of the cavity 84 in the inner tube 81 and the mouth of the first opening 13 of the protrusion body 75 are positioned facing to each other and have substantially the same shape.

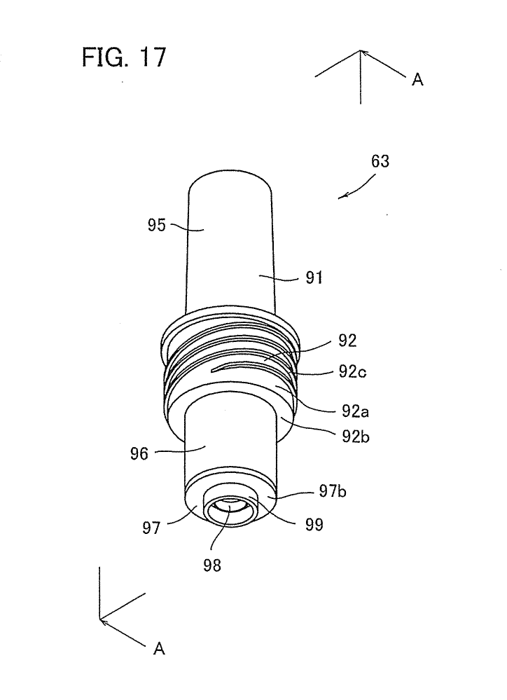

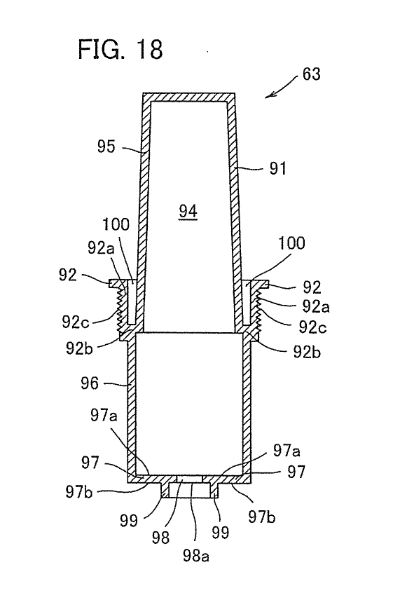

The ink tank section 63, as shown in FIGS. 17 and 18, mainly consists of a tank body 91 of a substantially columnar shape in appearance and a main body tube-engaging portion 92.

The tank body 91 has an internal space 94 formed by hollowing of an internal part as shown in FIG. 18. The tank body 91 has a rear portion 95 having inner and outer diameters narrowing from its center part backward. The tank body 91 has also a front portion 96 extending from its center part to its distal end with substantially the same inner and outer diameters.

As shown in FIG. 17, the distal end (lower end in FIGS. 17 and 18) of the tank body 91 has a bottom plate 97 shaped in a circular plate, which is disposed so as to block a front of the tank body 91. Referring to FIG. 18, an inner face (top face) 97a and an outer face (bottom face) 97b of the bottom plate 97 are substantially perpendicular to a longitudinal direction of the tank body 91.

Referring to FIGS. 17 and 18, the bottom plate 97 has at its center part an ink supply passage 98 communicating the internal space 94 of the tank body 91 with outside. The ink supply passage 98 is a throughhole penetrating from the outer face 97b to the inner face 97a of the bottom plate 97 and extends in a penetrating direction with a circular cross section. The outer face 97b and the inner face 97a have circular openings. Herein, an opening 98b formed in the outer face 97b of the bottom plate 97 has a diameter not particularly limited, but preferably of 2.0 mm to 7.0 mm and more preferably of 3.0 mm.

Further, the outer face 97b of the bottom plate 97 has an intermediate member-engaging portion 99, which surrounds the opening of the ink supply passage 98. The intermediate member-engaging portion 99 is an annular standing wall projecting substantially downward in a vertical direction from the outer face 97b of the bottom plate 97 and is positioned slightly outward away from an edge of the opening of the ink supply passage 98.

Referring to FIG. 18, the main body tube-engaging portion 92 is formed by a tubular portion 92a and a connecting portion 92b. The tubular portion 92a is positioned so as to surround a center part of the tank body 91 in the longitudinal direction. The connecting portion 92b connects a distal end (lower end in FIG. 18) of an inner periphery of the tubular portion 92a and an outer periphery of the tank body 91.

Herein, the inner periphery of the tubular portion 92a is positioned slightly outward away from the outer periphery of the tank body 91. The connecting portion 92b is positioned in between the distal end of the inner periphery of the tubular portion 92a and the outer periphery of the tank body 91. The connecting portion 92b is integrated with a part of the distal end of the inner periphery of the tubular portion 92 and a part of the outer periphery of the tank body 91 respectively, so as to become continuous with those without space therebetween. Therefore, the inner periphery of the tubular portion 92a and the outer periphery of the tank body 91 define an annular groove 100 closed at its distal end and opened at its proximal end.

Further, the tubular portion 92a is provided with an ink tank-helical groove 92c at its outer periphery.

Now, an assembly configuration of the applicator 60 of this embodiment will be described in detail below, making reference to FIG. 13.

The pen tip 6 is attached to a distal end of the distal portion 69 of the main body tube 61. The inner absorber 4 is disposed at the back of the pen tip 6 and in the internal space 71 of the distal portion 69. The inner absorber 4 is disposed in the main body tube 61 with stuffed in a tube (not shown) made of a proper material such as PP (polypropylene). The distal part of the inner absorber 4 contacts with the proximal part of the pen tip 6.

The intermediate member 62 is inserted in the internal space 71 of the distal portion 69 in a way that the protrusion 73 is located anteriorly and the base 74 is located posteriorly. Almost all parts of the protrusion body 75 and the two pressing pieces 76 of the protrusion 73 are inserted in the inner absorber 4. Specifically, parts from the distal end to the proximal end in an anteroposterior direction of the protrusion body 75 and the two pressing pieces 76 are inserted in the inner absorber 4. More specifically, the intermediate member 62 is inserted into the inner absorber 4 from the back of the absorber 4, so that the protrusion body 75 and the two pressing pieces 76 of the protrusion 73 press the inner absorber 4 forward from the back (from top down in FIG. 13).

In the internal space 71 of the distal portion 69, a part from a position slightly anterior to the distal face 77 of the base 74 of the intermediate member 62 to a position adjacent to the distal end of the internal space 71 defines the inner absorber arrangement portion 68.

The mouths of the first and second openings 13 and 14 of the protrusion 73 are substantially entirely covered with the inner absorber 4. As shown in FIG. 19, a part of a rear end (upper end in FIG. 19) of the inner absorber 4 enters the internal space 89 (cavity 21) of the protrusion 73 through the first opening 13. Hence, the inner absorber 4 is partly arranged adjacent to the distal end (lower end in FIG. 19) of the internal space 89 of the protrusion 73. In other words, a part of the inner absorber 4 is arranged at a position posterior to (above in FIG. 19) an opening face of the first opening 13 and the mouth of the first opening 13 is covered with the inner absorber 4.

The outer diameter of the base 74 (or the outer diameter of the outer tube 80) of the intermediate member 62 and the inner diameter of the distal portion 69 of the main body tube 61 are substantially the same, so that the intermediate member 62 is engaged with and fixed to the distal portion 69 of the main body tube 61.

The ink tank section 63 filled with the ink 7 in the internal space 94 is attached to the distal portion 69 of the main body tube 61 from behind the intermediate member 62. The ink tank-helical groove 92c formed around the outer periphery of the ink tank section 63 and the main body-helical groove 69e formed around the inner periphery of the distal portion 69 of the main body 61 are screwed together, so that the ink tank section 63 is fixed to the main body tube 61.

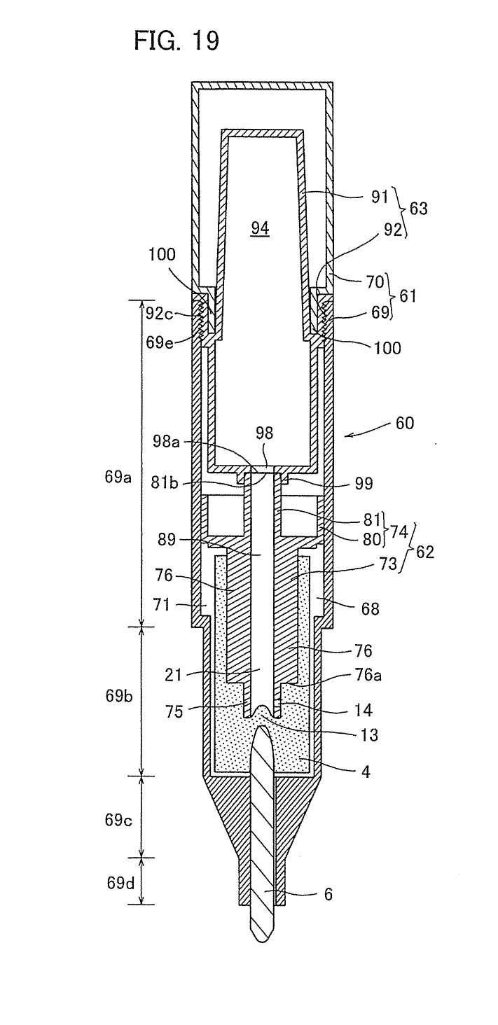

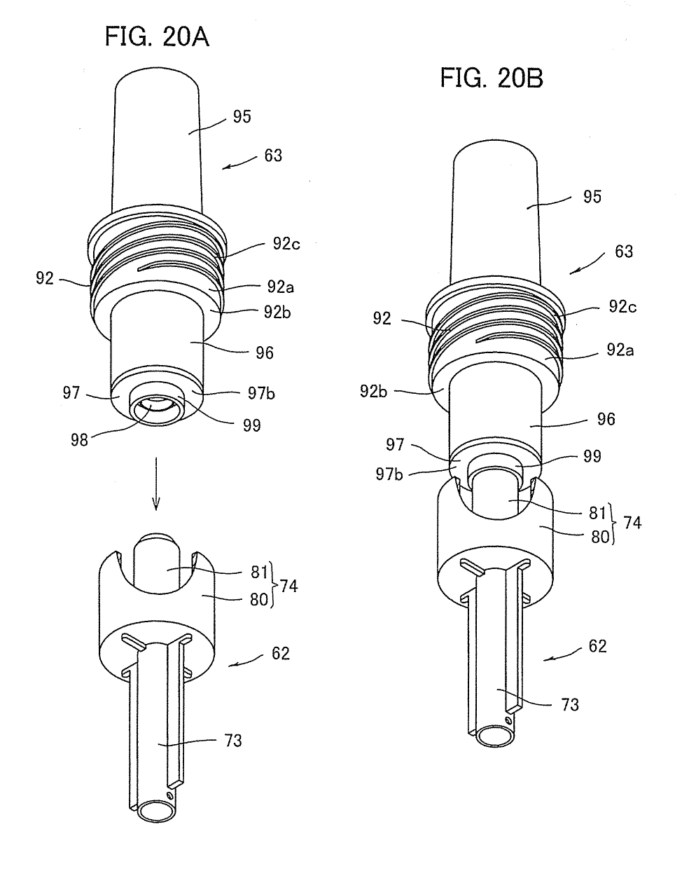

At this time, as shown in FIGS. 20A and 20B, the distal part of the inner tube 81 is inserted in the intermediate member-engaging portion (annular standing wall) 99. The outer diameter of the inner tube 81 and the inner diameter of the intermediate member-engaging portion 99 are substantially the same, so that the proximal part of the inner tube 81 is engaged with and fixed to the intermediate member-engaging portion 99. At this time, as shown in FIG. 13, the opening 98a located outside the ink supply passage 98 has contact with the opening 81b formed in the inner tube 81. That connects the ink supply passage 98 and the internal space 89, which become as if being an integrated throughhole.

Further, the proximal portion 70 of the main body tube 61 is attached to the ink tank section 63 from behind. Specifically, the distal end part of the proximal portion 70 of the main body tube 61 is inserted in the annular groove 100 formed in the ink tank section 63.

This is the end of the description of the assembly configuration of the applicator 60 of this embodiment.

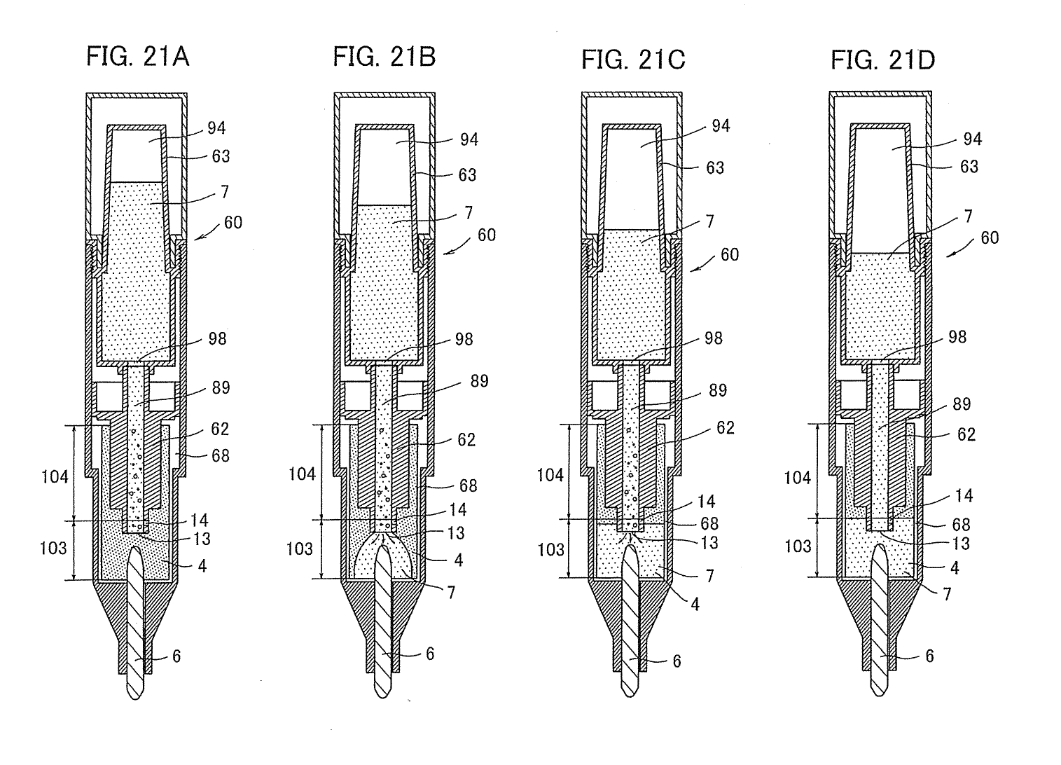

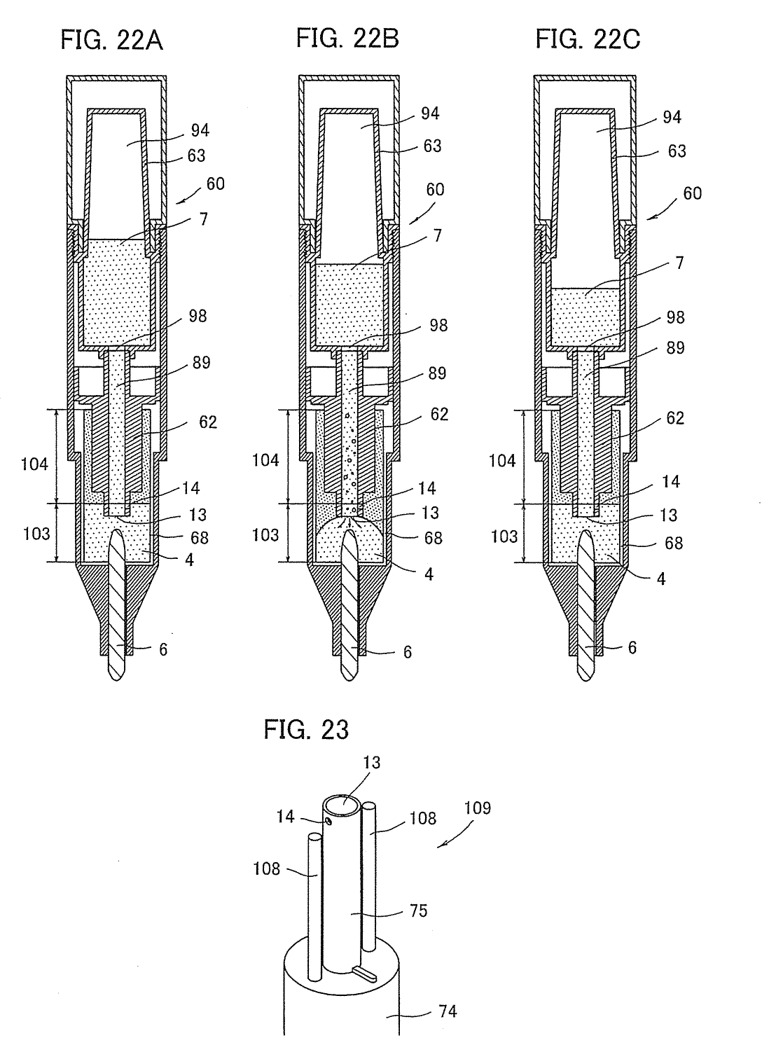

Now, a function of the applicator 60 of this embodiment will be further described below, making reference to FIGS. 21A to 22C.

The pen tip 6 being headed downwardly for writing, the ink 7 flows from the internal space 94 of the ink tank section 63 to the inner absorber arrangement portion 68 by gravity as shown in FIG. 21A. The ink 7 passes through the ink supply passage 98 to the lower part of the internal space 89 of the intermediate member 62. The ink 7 having flowed adjacent to the lower end of the protrusion 73 is drawn downwardly by its own gravity and a capillary force of the inner absorber 4. That supplies the ink 7 to the inner absorber arrangement portion 68 through the first opening 13. In short, the internal space 89 of the intermediate member 62 serves as an ink passage for supplying the ink 7.

In this embodiment, the pressing pieces 76 press the inner absorber 4 from above. That forms a medium density part 103 having a lower porosity at a lower part of the inner absorber 4. Specifically, press of the inner absorber 4 from above by the pressing pieces 76 forces a part of the pressed inner absorber 4 to be pushed downwardly and accumulated. That, in the inner absorber 4, forms a low density part 104 having a higher porosity and lower fiber density at an upper part and the medium density part 103 having a lower porosity and higher fiber density at the lower part. The pen tip 6 is a high density part having a higher fiber density than that of the medium density part 103 of the inner absorber 4.

In sum, this embodiment forms consecutive upper and lower parts having different fiber densities in the inner absorber 4, the fiber density becoming higher downwardly. The low density part 104, the medium density part 103, the high density part (pen tip 6) are consecutively located from the proximal end of the inner absorber 4 toward the distal end of the pen tip 6. Herein, in this embodiment, as shown in FIGS. 21a, the medium density part 103 is located at a part from the distal end of the inner absorber 4 to a vicinity of the upper end of the second opening 14, while the low density part 104 is located behind the vicinity of the upper end of the second opening 14.

That stably supplies the ink 7 to the pen tip 6. Even if the ink 7 is of a type that only its gravity cannot allow the ink 7 to reach the mouth of the first opening 13, for example, the ink 7 is drawn from the intermediate member 62 to the inner absorber 4 and flowed from the inner absorber 4 to the pen tip 6.

At this time, outside air (slight amount of air) is introduced into the internal space 94 of the ink tank section 63 through the second opening 14 lying unused for supply of the ink 7. The ink 7 and the outside air are exchanged within the internal space 94, so that the ink 7 is roundly supplied to the inner absorber arrangement portion 68 through the first opening 13. Herein, the second opening 14 is located nearer to the ink tank section 63 than the first opening 13 and above the first opening 13 when the pen tip 6 is headed downwardly. Therefore, the ink 7 is supplied through the first opening 13 having a high water pressure to the inner absorber arrangement portion 68, so as not to be supplied through the second opening 14.

The ink 7 can have a preferable flow rate by making the diameters and/or areas of the first opening 13 and the second opening 14 to be the above-mentioned preferable sizes and by arranging the distance of the second opening 14 from the distal end of the protrusion to be the above-mentioned preferable length. That stably supplies the ink 7 to the inner absorber arrangement portion 68.

The ink 7 continues to be supplied to the inner absorber arrangement portion 68, so that the inner absorber 4 is being impregnated with the ink 7 as shown in FIG. 21B. At this time, the first opening 13 and the inner absorber 4 are in contact with each other, so that the ink 7 having approached the first opening 13 is drawn by the capillary force of the inner absorber 4. That avoids flow of the ink 7 being disrupted around the first opening 13 by surface tension.

As the inner absorber 4 is being impregnated with the ink 7, a level of the ink 7 in the inner absorber arrangement portion 68 is rising (a border line of the level is approaching the ink tank section 63). The level of the ink 7 in the inner absorber arrangement portion 68 eventually reaches a level (position) of the first opening 13, then rising above the level of the first opening 13 (position near the ink tank section 63) as shown in FIG. 21C.

As the level of the ink 7 in the inner absorber arrangement portion 68 rises in this way, the inner absorber arrangement portion 8 is eventually filled with the ink 7 to the level of the second opening 14 as shown in FIG. 21D. That gets the second opening 14 into liquid seal by the impregnated ink 7, thereby substantially sealing the second opening 14. Then, outside air is unable to be introduced into the internal space 94 of the ink tank section 63, which stops supplying the ink 7 to the inner absorber arrangement portion 68. At this time, the inner absorber 4 is sufficiently impregnated with the ink 7 at its front part (lower part in FIGS. 21A to 22C), while the inner absorber 4 is insufficiently impregnated with the ink 7 at its rear part (upper part in FIGS. 21A to 22C). Herein, the rear part of the inner absorber 4 is normally impregnated with the ink 7, but unless surrounding temperature has increased.

Continuation of writing, with the front part of the inner absorber 4 impregnated with the ink 7 as shown in FIG. 22A, gradually reduces the ink 7 impregnated in the inner absorber 4 and then, as shown in FIG. 22B, the liquid seal of the second opening 14 is released. Then, outside air is roundly introduced into the ink tank 3 again, so that the ink 7 is started to be supplied to the inner absorber arrangement portion 68. The ink 7 is supplied to the inner absorber arrangement portion 68 until the impregnated ink 7 gets the second opening 14 into liquid seal again, as shown in FIG. 22C. As described above, in every reduction of the ink 7 as writing, the ink 7 is supplied to the inner absorber arrangement portion 68 and the inner absorber 4. The ink 7 having been supplied to the inner absorber 4 is difficult to flow from the medium density part 103 to the low density part 104. In other words, the ink 7 supplied to the inner absorber 4 is easy to flow toward the pen tip 6, so as to be stably supplied to the pen tip 6.

In the above-mentioned eighth embodiment, the mouths of the first and second openings 13 and 14 are entirely covered with the inner absorber 4, but the present invention is not limited to such a configuration. The mouths of the first and/or second openings 13 and/or 14 are not necessarily covered with the inner absorber 4, or only a part of the mouths of those may be covered with the inner absorber 4. In short, it is only necessary to arrange the protrusion 73 and the inner absorber 4 so that the ink 7 located adjacent to the distal end of the protrusion 73 in the internal space 89 is drawn to the inner absorber 4 by the capillary force of the inner absorber 4.

The above-mentioned eighth embodiment has such a configuration that the pressing pieces 76 is shaped in a flat plate and has contact with the side face of the protrusion body 75 and the distal face 77 of the base 74, but the intermediate member of the present invention is not limited to such the configuration. As shown in a ninth embodiment in FIG. 23, for example, it is possible to employ an intermediate member 109 provided with pressing pieces 108 having no contact with the protrusion body 75 and projecting forward from the base 74.

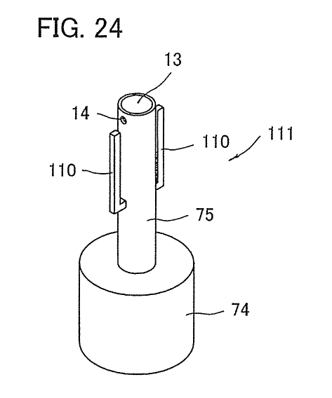

Alternatively, as shown in a tenth embodiment in FIG. 24, it is possible to employ an intermediate member 111 provided with pressing pieces 110 projecting from the protrusion body 75 with no contact with the base 74.

Further, a shape of the pressing piece of the present invention is not particularly limited and may be of a round bar (see FIG. 23) as shown in the ninth embodiment or of a hook (L-shaped plate) (see FIG. 24) as shown in the tenth embodiment. Hence, the pressing piece may extend in a polygonal cross section like a quadrangle, in a circular cross section, or with partly bending.

In short, the pressing piece of the present invention is only necessary to make at least a part of the inner absorber located adjacent to an ink outlet (first opening 13) of the intermediate member to have a high fiber density by pressing the inner absorber.

In each of the above-mentioned embodiments, the intermediate member is provided with two pressing pieces, but may be provided with one pressing piece or more than two pressing pieces.

In each of the above-mentioned embodiments, the intermediate member is brought into contact with the inner absorber so that the protrusion of the intermediate member and the upper face of the inner absorber form an angle of substantially 90 degrees, but the present invention is not limited to such the angle. The angle formed by the protrusion of the intermediate member and the upper face of the inner absorber is not particularly limited, but preferably between 70 to 90 degrees.

The ink used in each of the above-mentioned embodiments is not particularly limited, but ink having a viscosity of more than 6.7 mPa·s, an angle of contact with a solid surface of less than 53.8 degrees, and a surface tension of less than 33.5 mN/m is suitably used.

### BRIEF DESCRIPTION OF NUMERALS

1, 60 applicator
2 main body tube
3 ink tank (application liquid reservoir)
4 inner absorber (application liquid-occlusion body)
5, 40, 41, 62, 109, 111 intermediate member (channel forming portion)
6 pen tip (applying body)
7 ink (application liquid)
8 inner absorber arrangement portion
11, 51, 52, 73 protrusion
12, 44, 74 base
13, 33, 53a first opening (communication opening)
14, 34, 53b second opening (communication opening)
21 cavity
27, 89 internal space (internal opening)
63 ink tank section (application liquid reservoir)
76, 108, 110 pressing piece (pressing portion)
98 ink supply passage

1. An applicator, comprising:
an application liquid reservoir in which filled application liquid is flowable;
an applying body for applying the application liquid;
an application liquid-occlusion body located between the application liquid reservoir and the applying body and designed to be impregnated with the application liquid; and
a channel forming portion located between the application liquid reservoir and the liquid-occlusion body and having a channel in which the application liquid is flowable,
wherein the channel forming portion has a protrusion,
the protrusion protruding in a protruding direction toward the applying body and having a cavity and more than one communication openings communicated with the cavity.

2. The applicator as defined in claim 1,
the protrusion being in contact with the occlusion body.

3. The applicator as defined in claim 1,
the communication openings including at least one communication opening located adjacent to a distal end of the protrusion and another communication opening located nearer to a proximal end of the protrusion than the at least one communication opening.

4. The applicator as defined in claim
wherein the channel forming portion has a pressing portion,
the pressing portion being at least partly in contact with the liquid-occlusion body from above.

5. The applicator as defined in claim 4,
the pressing portion having a lower end positioned above the communication openings.

6. The applicator as defined in claim
wherein the channel forming portion comprises a base and the protrusion,
the base and the protrusion being of columnar shapes with different diameters and each having a cavity passing through its center part, and
the communication openings being located at a circular face at a distal end of the protrusion and at a side face of and adjacent to the distal end of the protrusion.

7. The applicator as defined in claim 6,
the pressing portion being a plate-like projection projecting outwardly from and substantially perpendicularly to the side face of the protrusion and extending from a proximal end to a vicinity of a distal end in the protruding direction of the protrusion, and
the opening formed at the side face of and adjacent to the distal end of the protrusion having a central axis extending substantially in parallel with the projecting direction of the pressing portion.

8. The applicator as defined in claim 1,
the liquid-occlusion body being partly arranged within the channel forming portion.

9. The applicator as defined in claim 1,
the channel forming portion and the application liquid reservoir being integrally formed.

10. The applicator as defined in one of claim 1,
the channel forming portion and the application liquid reservoir being attachable to and detachable from each other.

11. The applicator as defined in claim 10,
the application liquid reservoir having a throughhole at its lower part, through which throughhole an internal space of the reservoir communicates with an outer space, and
the channel forming portion comprising the base and the protrusion, the base having a tubular portion communicated with the cavity of the protrusion,
so that the throughhole and the tubular portion are communicated with each other when the channel forming portion and the application liquid reservoir are attached to each other.
